(19) United States
(12) Patent Application Publication
(10) Pub. No.: US 2026/0370517 A1
(43) Pub. Date: Nov. 19, 2026

(54) MULTIPLE RADIO ACCCESS TECHNOLOGY SPECTRUM SHARING

(71) Applicant: Nokia Technologies Oy, Espoo (FI)

(72) Inventors: Navin HATHIRAMANI, Dallas, TX (US); Karri Markus RANTA-AHO, Espoo (FI)

(21) Appl. No.: 19/137,126

(22) PCT Filed: Nov. 9, 2023
(86) PCT No.: PCT/EP2023/081250

§ 371 Date: Jun. 9, 2025

(30) Foreign Application Priority Data
Dec. 12, 2022 (GB) 2218608.4

(51) Int. Cl. H04L 25/02; H04W 16/14; H04W 72/23

(52) U.S. Cl. CPC H04L 25/0224; H04W 16/14; H04W 72/23

(57) ABSTRACT

An apparatus configured for 6G operation and operable to perform channel estimation for a 6G channel. The apparatus performs the channel estimation by monitoring for reference signals within resource elements in at least a portion of a frequency band, the resource elements being allocated to an other radio access technology. Channel estimation is performed based on the monitored reference signals.

### TECHNOLOGICAL FIELD

Various example embodiments relate to reference signals in the context of dynamic spectrum sharing.

### BACKGROUND

Dynamic Spectrum Sharing (DSS) involves at least two radio access technologies sharing the same spectrum. “Dynamic” means that channel allocation is not static but varies in time and/or frequency (e.g. from one subframe/slot to another). DSS is increasingly important as new radio access technologies are developed.

A user equipment UE within a cell needs to perform channel estimation before it can decode information transmitted in e.g., a control channel. This channel estimation is performed by detecting reference signals broadcast by network nodes, such as base stations or gNBs, within the frequency band of the control channel. With the development of the 6G radio access technology, it would be desirable to provide a resource efficient way of broadcasting these reference signals whilst maintaining a high quality of service in the context of cells using DSS.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus configured for 6G operation, said apparatus comprising: at least one processor; and at least one memory storing instructions that when executed by the at least one processor cause the apparatus at least to perform: channel estimation for a 6G channel by: monitoring for reference signals within resource elements in at least a portion of a frequency band, said resource elements being allocated to an other radio access technology; and performing said channel estimation based on said monitored reference signals.

Where there is dynamic spectrum sharing within cells that use different radio access technologies and overlap both geographically and in frequency band, then an efficient and effective way of providing reference signals for use in channel estimation for the apparatus configured for 6G operation may be to provide that apparatus with information regarding the reference signals that are transmitted or broadcast by the network node of the other radio access technology cell, such that the apparatus can monitor for these reference signals in resource elements allocated to the other radio access technology. In this way, the resources available for the transmission of other 6G signals is increased. The frequency band that is allocated to the other radio access technology is a frequency band that is allocated for use by that technology and at least a portion of which may be allocated for use by the 6G cell. The resource elements on which the reference signals are transmitted are allocated to the other radio access technology for the transmission of its reference signals.

The apparatus may perform channel estimation by monitoring for predefined reference signals in frequency/time locations and matching signals received that correspond to the predefined signals and frequency/time locations to the expected signals and performing channel estimation.

In some example embodiments, said reference signals are common to both said other radio access technology and to 6G. That is both 6G and the other radio access technology use the same configuration of reference signals.

In some example embodiments, said reference signals comprise demodulation reference signals DMRS.

In some example embodiments, said reference signals are demodulation reference signals for physical download control channels PDCCH.

In some example embodiments, said other radio access technology comprises 5G.

In some example embodiments, said monitored at least a portion of said frequency band comprises at least a frequency band for transmission of a 6G physical downlink control channel PDCCH.

In some example embodiments, said apparatus is further caused prior to performing said channel estimation to receive an indicator indicating that said apparatus is within radio coverage of a 6G cell using dynamic spectrum sharing with said other radio access technology and to commence said step of monitoring in response to receipt of said indicator.

In some example embodiments, said apparatus is further caused to perform: receiving a configuration indicator indicating a configuration of a set of resource elements and a frequency band for said reference signals, and in response to receipt of said configuration indicator monitoring within at least a portion of said frequency band for said reference signals; and performing said channel estimation based on said monitored reference signals and said at least a portion of said frequency band.

In some example embodiments, said configuration indicator indicates a frequency band of a control resource set of said other radio access technology as said frequency band, said apparatus performing channel estimation in dependence upon at least a portion of said frequency band of said other radio access technology.

In some example embodiments, said frequency band comprises the frequency band of the 6G CORESET.

In some example embodiments, said monitored a least portion of said frequency band comprises the frequency band of the PDCCH channel within the 6G CORESET.

In some example embodiments a frequency band of a control resource set of said other radio technology is the same or wider than a frequency band of the 6G PDCCH.

In some example embodiments, said configuration indicator indicates a frequency band comprising a frequency band that is wider than a frequency band of said control resource set of said other radio access technology.

In some example embodiments, the 6G PDCCH may have a wider frequency band than the CORESET of the other radio access technology and in this case, the configuration indicator may indicate a frequency band that is wider than this CORESET.

In some example embodiments, said configuration indicator is received in at least one of the following: a master information block or a system information block.

In some example embodiments said apparatus is further caused to perform: receiving signals on a 6G physical downlink control channel; and performing decoding operations on said signals using said channel estimation.

According to various, but not necessarily all, example embodiments of the invention there is provided an apparatus configured to support providing radio coverage in a 6G cell and configured to dynamically share a radio spectrum with a further apparatus using another radio access technology, said apparatus comprising: at least one processor; and at least one memory storing instructions that when executed by the at least one processor cause the apparatus at least to perform: receiving information from said further apparatus providing radio coverage in a cell of said other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; generating an indication of configuration information relating to said resource elements; and transmitting said indication to user equipment configured to support 6G operation within said cell.

A 6G cell may be configured to dynamically share a radio spectrum with a further apparatus using another radio access technology. Embodiments seek to provide an apparatus that can effectively and efficiently share the spectrum by providing some coordination between the apparatus allowing the 6G apparatus to re-use the reference signals of the further apparatus. This coordination may be provided by the apparatus supporting providing radio coverage in the 6G cell receiving information from the further apparatus indicating the configuration of reference signals transmitted by this apparatus. It may then forward this information to user equipment configured for 6G operation within its cell allowing them to use the reference signals of this other apparatus to perform their channel estimation. This allows the apparatus not to transmit these signals itself and therefore increases the bandwidth available to it for other signals. It should be noted that the transmission of the reference signals may be by broadcast or unicast.

In some embodiments, said indication of said configuration of resource elements comprises an indication of a frequency band in which said resource elements are transmitted.

It should be noted that the reference signals location in time and frequency may be something that is defined in the standard and the UE may just be sent the configuration of the physical downlink control channel that is the type, time and frequency location and in which case it can determine where to monitor for the reference signals. The indication may therefore simply be an indication of the PDCCH configuration alternatively it may be an actual indication of where the reference signal is located in time and frequency.

In some example embodiments, said frequency band comprises a frequency band of a control resource set of said other radio access technology.

In some example embodiments, said frequency band comprises a frequency band of a control resource set of said 6G cell.

In some example embodiments, said processor is configured to cause said apparatus to perform: generating an indicator indicating that said reference signals should be generated and transmitted irrespective of whether user equipment configured for the other radio access technology require the signals; and transmitting said indicator to said further apparatus.

In some example embodiments, said processor is configured to cause said apparatus to perform: determining that a user equipment configured for 6G operation is within said cell and in response: generating an indicator indicating that said reference signals should be generated and transmitted for a predetermined time; and transmitting said indicator to said further apparatus.

In some example embodiments, said processor is configured to cause said apparatus to perform: generating an indicator indicating a frequency band for transmission of said reference signals by said further apparatus when said further apparatus determines that user equipment configured for operation using the other radio access technology do not require the reference signals; and transmitting said indicator to said further apparatus.

In some example embodiments, said processor is configured to cause said apparatus to perform: in response to receiving an indication that said further apparatus is not currently transmitting said reference signals, to generate and transmit said reference signals using at least some of said resource elements used by said further apparatus when transmitting said reference signals.

According to various, but not necessarily all, example embodiments of the invention there is provided an apparatus configured to support providing radio coverage in a 5G cell and configured to dynamically share a radio spectrum with an apparatus providing radio coverage in a 6G cell, said 6G cell at least partially overlapping geographically in frequency band with said 5G cell, said apparatus, comprising: at least one processor; and at least one memory storing instructions that when executed by the at least one processor cause the apparatus at least to perform: generating configuration information for transmission to said apparatus supporting providing radio coverage in said 6G cell, said configuration information including an indication of a configuration of resource elements used by said apparatus to transmit reference signals; transmitting said reference signals on said resource elements.

Although embodiments may be applicable to a number of radio access technologies, they are particularly applicable to 5G. Where there is a 5G cell overlapping with a 6G cell and they are dynamically sharing a spectrum then the 5G cell may generate configuration information indicative of the resource elements that it uses for transmitting its reference signals to the 6G cell such that the 6G cell can configure user equipment within the cell to use these reference signals.

In some example embodiments, said indication of a configuration of resource elements comprises an indication of a frequency band in which said resource elements are transmitted.

In some example embodiments, the apparatus is further caused to perform: receiving an indication from said apparatus supporting radio coverage in said 6G cell indicating that said reference signals should be transmitted irrespective of whether user equipment configured for 5G operation require said reference signals; and in response, transmitting said reference signals irrespective of whether user equipment configured for 5G operation are within said 5G cell and require said reference signals.

In some example embodiments, the apparatus is further caused to perform: receiving an indication from said apparatus supporting radio coverage in said 6G cell indicating that said reference signals should be transmitted in a different predefined frequency band when user equipment configured for 5G operation do not require said reference signals; and determining whether user equipment configured for 5G operation are within said 5G cell and require said reference signals if so:
transmitting said reference signals in a frequency band of the 5G control resource set; and if not
transmitting said reference signals in said predefined frequency band.

According to various, but not necessarily all, example embodiments of the invention there is provided a method performed by a user equipment, said method comprising:
performing channel estimation for a 6G channel by: monitoring for reference signals within resource elements in at least a portion of a frequency band, said resource elements being allocated to an other radio access technology; and performing said channel estimation based on said monitored reference signals.

In some example embodiments, said method further comprises: receiving an indicator indicating that said apparatus is within radio coverage of a 6G cell using dynamic spectrum sharing with said other radio access technology and in response commencing said step of monitoring.

In some example embodiments, said indicator comprises a configuration indicator indicating a configuration of a set of resource elements and a frequency band for said reference signals, and said step of monitoring comprises in response to receipt of said configuration indicator monitoring within at least a portion of said frequency band for said reference signals; and performing said channel estimation based on said monitored reference signals and said at least a portion of said frequency band.

In some example embodiments, said configuration indicator indicates a frequency band of a control resource set of said other radio access technology as said frequency band, said channel estimation is performed in dependence upon at least a portion of said frequency band of said other radio access technology.

In some example embodiments, said method further comprises performing decoding operations on said signals using said channel estimation.

According to various, but not necessarily all, example embodiments of the invention there is provided a method performed by an apparatus for supporting providing radio coverage in a 6G cell and configured to dynamically share a radio spectrum with a further apparatus using another radio access technology, said method comprising: receiving information from the further apparatus providing radio coverage in a cell of the other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; generating an indication of configuration information relating to said resource elements; and transmitting said indication to user equipment configured to support 6G operation within said cell.

In some example embodiments, said step of generating further comprises generating an indication that said reference signals should be generated and transmitted irrespective of whether user equipment configured for the other radio access technology require the signals, and said step of transmitting comprises transmitting said indication.

In some example embodiments, said method further comprises: determining that a user equipment configured for 6G operation is within said cell and in response: generating an indication that said reference signals should be generated and transmitted for a predetermined time.

In some example embodiments, said step of generating generates an indication of a frequency band for transmission of said reference signals by said further apparatus when said further apparatus determines that user equipment configured for operation using the other radio access technology do not require the reference signals.

In some example embodiments, said steps of generating and transmitting generates said reference signals and transmits said reference signals using at least some of said resource elements used by said further apparatus in response to receiving an indication that said further apparatus is not currently transmitting said reference signals.

According to various, but not necessarily all, example embodiments of the invention there is provided a method performed by an apparatus configured to support providing radio coverage in a 5G cell and configured to dynamically share a radio spectrum with an apparatus providing radio coverage in a 6G cell, said 6G cell at least partially overlapping geographically and in a frequency band with said 5G cell, said method, comprising: generating configuration information for transmission to said apparatus supporting providing radio coverage in said 6G cell, said configuration information including an indication of a configuration of resource elements used by said apparatus to transmit reference signals; transmitting said reference signals on said resource elements.

In some example embodiments, the method further comprises: receiving an indication from said apparatus supporting radio coverage in said 6G cell indicating that said reference signals should be transmitted irrespective of whether user equipment configured for 5G operation require said reference signals; and transmitting said reference signals irrespective of whether user equipment configured for 5G operation are within said 5G cell and require said reference signals in response to receiving said indication.

In some example embodiments, said step of receiving comprises receiving an indication from said apparatus supporting radio coverage in said 6G cell indicating that said reference signals should be transmitted in a different predefined frequency band when user equipment configured for 5G operation do not require said reference signals; and in response determining whether user equipment configured for 5G operation are within said 5G cell and require said reference signals and: where so transmitting said reference signals in a frequency band of the 5G control resource set; and wherein not transmitting said reference signals in said predefined frequency band.

According to various, but not necessarily all, example embodiments of the invention there is provided a computer program product comprising computer program instructions which when executed by a processor on a user equipment are configured to control said user equipment to: perform channel estimation for a 6G channel by:
monitoring for reference signals within resource elements in at least a portion of a frequency band, said resource elements being allocated to an other radio access technology; and
performing said channel estimation based on said monitored reference signals.

According to various, but not necessarily all, example embodiments of the invention there is provided a computer program product comprising computer program instructions which when executed by a processor on an apparatus for supporting providing radio coverage in a 6G cell and configured to dynamically share a radio spectrum with a further apparatus using another radio access technology, are configured to control said apparatus to: receive information from the further apparatus providing radio coverage in a cell of the other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; generate an indication of configuration information relating to said resource elements; and transmit said indication to user equipment configured to support 6G operation within said cell.

According to various, but not necessarily all, example embodiments of the invention there is provided a computer program product comprising computer program instructions which when executed by at least one processor on an apparatus configured to support providing radio coverage in a 5G cell and configured to dynamically share a radio spectrum with an apparatus providing radio coverage in a 6G cell, at least partially overlapping geographically and in a frequency band, are configured to control said apparatus to: generate configuration information for transmission to said apparatus supporting providing radio coverage in said 6G cell, said configuration information including an indication of a configuration of resource elements used by said apparatus to transmit reference signals; and transmit said reference signals on said resource elements.

According to various, but not necessarily all, example embodiments of the invention, there is provided an apparatus configured for 6G operation, said apparatus comprising:
means for monitoring for reference signals within resource elements in at least a portion of a frequency band, said resource elements being allocated to an other radio access technology;
and means for performing channel estimation for a 6G channel based on said monitored reference signals.

In some example embodiments said channel estimation is for a 6G physical downlink control channel.

In some example embodiments, said apparatus further comprises: means for receiving an indicator indicating that said apparatus is within radio coverage of a 6G cell using dynamic spectrum sharing with said other radio access technology, said means for monitoring being configured to commence monitoring in response to receipt of said indicator.

In some example embodiments, said indicator comprises a configuration indicator indicating a configuration of a set of resource elements and a frequency band for said reference signals, and said means for monitoring is configured to monitor within at least a portion of said frequency band for said reference signals in response to receipt of said configuration indicator; and said means for performing said channel estimation is configured to perform said channel estimation based on said monitored reference signals and said at least a portion of said frequency band.

In some example embodiments, said configuration indicator indicates a frequency band of a control resource set of said other radio access technology as said frequency band, said means for performing channel estimation is configured to perform channel estimation in dependence upon at least a portion of said frequency band of said other radio access technology.

In some example embodiments, said apparatus further comprises: means for receiving signals on a 6G physical downlink control channel; and means for decoding said signals using said channel estimation.

According to various, but not necessarily all, example embodiments of the invention, there is provided an apparatus configured for 6G operation, said apparatus comprising: circuitry configured to monitor for reference signals within resource elements in at least a portion of a frequency band, said resource elements being allocated to an other radio access technology; and circuitry configured to perform channel estimation for a 6G channel based on said monitored reference signals.

In some example embodiments, said means for receiving comprises circuitry configured to receive.

In some example embodiments, said means for determining comprises circuitry configured to determine.

In some example embodiments, said means for decoding comprises circuitry configured to decode.

According to various, but not necessarily all, example embodiments of the invention, there is provided an apparatus configured to support providing radio coverage in a 6G cell and configured to dynamically share a radio spectrum with a further apparatus using another radio access technology, said apparatus comprising: means for receiving information from said further apparatus providing radio coverage in a cell of said other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; means for generating an indication of configuration information relating to said resource elements; and means for transmitting said indication to user equipment configured to support 6G operation within said cell.

In some example embodiments, said means for generating is further configured to generate an indication that said reference signals should be generated and transmitted irrespective of whether user equipment configured for the other radio access technology require the signals, and said means for transmitting is configured to transmit said indication.

In some example embodiments, said apparatus further comprises: means for determining that a user equipment configured for 6G operation is within said cell and in response: said means for generating is configured to generate an indication that said reference signals should be generated and transmitted for a predetermined time

In some example embodiments, said means for generating is configured to generate an indication of a frequency band for transmission of said reference signals by said further apparatus when said further apparatus determines that user equipment configured for operation using the other radio access technology do not require the reference signals

In some example embodiments, said means for generating and transmitting are configured to generate said reference signals and transmit said reference signals using at least some of said resource elements used by said further apparatus when transmitting said reference signals in response to receiving an indication that said further apparatus is not currently transmitting said reference signals.

According to various, but not necessarily all, example embodiments of the invention, there is provided an apparatus configured to support providing radio coverage in a 6G cell and configured to dynamically share a radio spectrum with a further apparatus using another radio access technology, said apparatus comprising: circuitry configured to receive information from said further apparatus providing radio coverage in a cell of said other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; circuitry configured to generate an indication of configuration information relating to said resource elements; and circuitry configured to transmit said indication to user equipment configured to support 6G operation within said cell.

In some example embodiments, said means for determining comprises circuitry configured to determine.

According to various, but not necessarily all, example embodiments of the invention, there is provided an apparatus configured to support providing radio coverage in a 5G cell and configured to dynamically share a radio spectrum with an apparatus providing radio coverage in a 6G cell, said 6G cell at least partially overlapping geographically in frequency band with said 5G cell, said apparatus, comprising: means for generating configuration information for transmission to said apparatus supporting providing radio coverage in said 6G cell, said configuration information including an indication of a configuration of resource elements used by said apparatus to transmit reference signals; means for transmitting said reference signals on said resource elements.

In some example embodiments, the apparatus further comprises: means for receiving an indication from said apparatus supporting radio coverage in said 6G cell indicating that said reference signals should be transmitted irrespective of whether user equipment configured for 5G operation require said reference signals; said means for transmitting being configured to transmit said reference signals irrespective of whether user equipment configured for 5G operation are within said 5G cell and require said reference signals in response to receiving said indication.

In some example embodiments, said means for receiving is configured to receive an indication from said apparatus supporting radio coverage in said 6G cell indicating that said reference signals should be transmitted in a different predefined frequency band when user equipment configured for 5G operation do not require said reference signals; said apparatus comprises means for determining in response to receipt of said indication whether user equipment configured for 5G operation are within said 5G cell and require said reference signals and: said means for transmitting being configured to transmit said reference signals in a frequency band of the 5G control resource set if so; and said means for transmitting being configured to transmit said reference signals in said predefined frequency band if not.

In some example embodiments, said apparatus further comprises: circuitry configured to receive an indicator indicating that said apparatus is within radio coverage of a 6G cell using dynamic spectrum sharing with said other radio access technology, said circuitry configured to monitor being configured to commence monitoring in response to receipt of said indicator.

In some example embodiments, said indicator comprises a configuration indicator indicating a configuration of a set of resource elements and a frequency band for said reference signals, and said means for monitoring is configured to monitor within at least a portion of said frequency band for said reference signals in response to receipt of said configuration indicator; and said means for performing said channel estimation is configured to perform said channel estimation based on said monitored reference signals and said at least a portion of said frequency band.

In some example embodiments, said configuration indicator indicates a frequency band of a control resource set of said other radio access technology as said frequency band, said means for performing channel estimation is configured to perform channel estimation in dependence upon at least a portion of said frequency band of said other radio access technology.

In some example embodiments, said apparatus further comprises: means for receiving signals on a 6G physical downlink control channel; and means for decoding said signals using said channel estimation.

According to various, but not necessarily all, example embodiments of the invention, there is provided an apparatus configured to support providing radio coverage in a 5G cell and configured to dynamically share a radio spectrum with an apparatus providing radio coverage in a 6G cell, said 6G cell at least partially overlapping geographically in frequency band with said 5G cell, said apparatus, comprising: circuitry configured to generate configuration information for transmission to said apparatus supporting providing radio coverage in said 6G cell, said configuration information including an indication of a configuration of resource elements used by said apparatus to transmit reference signals; circuitry configured to transmit said reference signals on said resource elements.

In some example embodiments, said means for receiving comprises circuitry configured to receive or a receiver.

In some example embodiments, said means for decoding comprises circuitry configured to decode or a decoder.

According to various, but not necessarily all, example embodiments of the invention, there is provided a non-transitory computer readable medium comprising program instructions stored thereon for performing at least the following: channel estimation for a 6G channel by: in response to receipt of reference signals received within resource elements in at least a portion of a frequency band, said resource elements being allocated to an other radio access technology performing channel estimation based on said monitored reference signals.

In some example embodiments, the program instructions are further for performing the following: in response to receipt of signals on a 6G physical downlink control channel; performing decoding operations on said signals using said channel estimation.

According to various, but not necessarily all, example embodiments of the invention, there is provided a non-transitory computer readable medium comprising program instructions stored thereon for performing at least the following: in response to receipt of information from said further apparatus providing radio coverage in a cell of said other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals; generating an indication of configuration information relating to said resource elements.

In some example embodiments, the program instructions are further for performing the following: generating an indicator indicating that said reference signals should be generated and transmitted irrespective of whether user equipment configured for the other radio access technology require the signals.

In some example embodiments, the program instructions are further for performing the following: determining that a user equipment configured for 6G operation is within said cell and in response: generating an indicator indicating that said reference signals should be generated and transmitted for a predetermined time.

In some example embodiments, the program instructions are further for performing the following: generating an indicator indicating a frequency band for transmission of said reference signals by said further apparatus when said further apparatus determines that user equipment configured for operation using the other radio access technology do not require the reference signals

In some example embodiments, the program instructions are further for performing the following: in response to receiving an indication that said further apparatus is not currently transmitting said reference signals, generating said reference signals for transmission using at least some of said resource elements used by said further apparatus when transmitting said reference signals.

According to various, but not necessarily all, example embodiments of the invention, there is provided a non-transitory computer readable medium comprising program instructions stored thereon for performing at least the following: generating configuration information for transmission to said apparatus supporting providing radio coverage in said 6G cell, said configuration information including an indication of a configuration of resource elements used by said apparatus to transmit reference signals.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

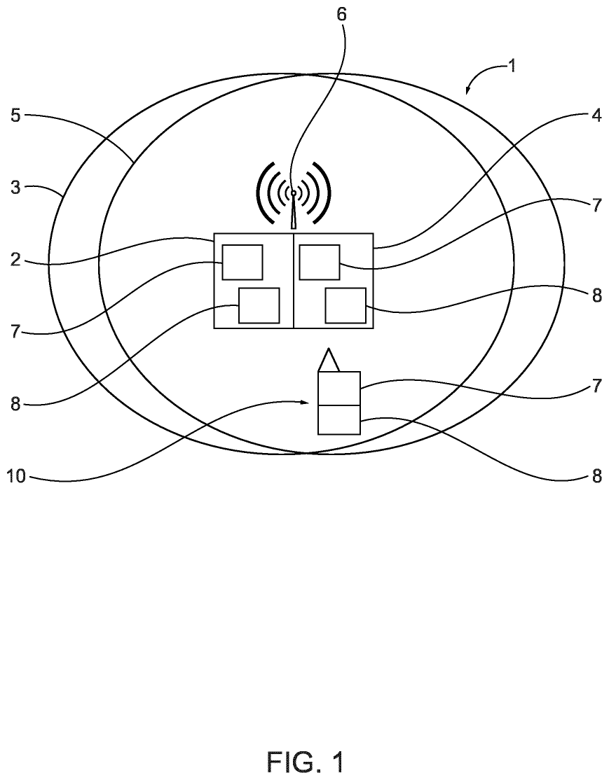

FIG. 1 illustrates an example embodiment of overlapping cells, network nodes and user equipment;

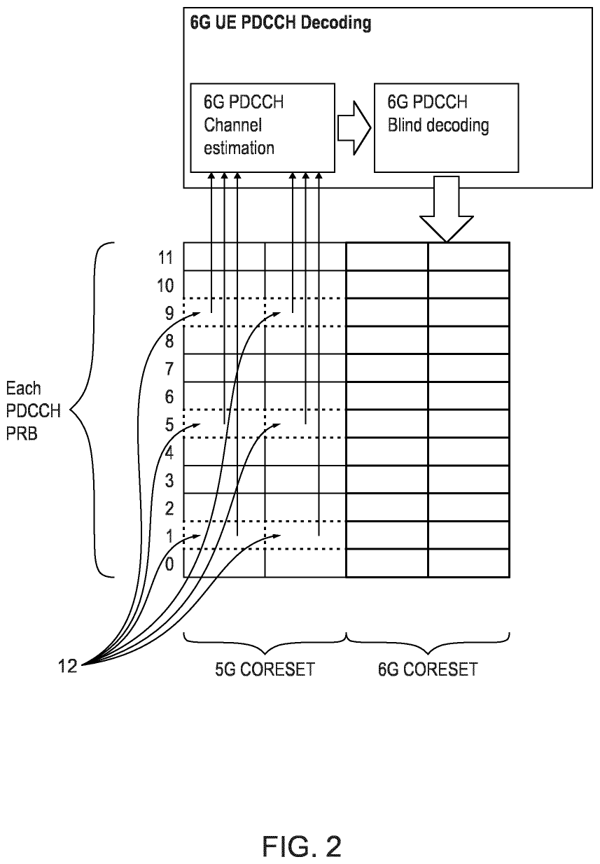

FIG. 2 illustrates the control resource sets for 5G and 6G cells dynamically sharing spectrum;

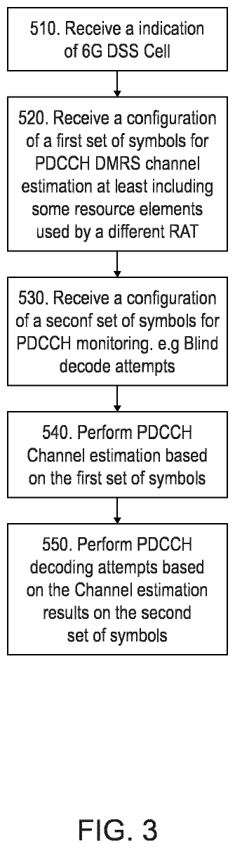

FIG. 3 schematically shows a flow diagram of a method performed at a user equipment according to an example embodiment;

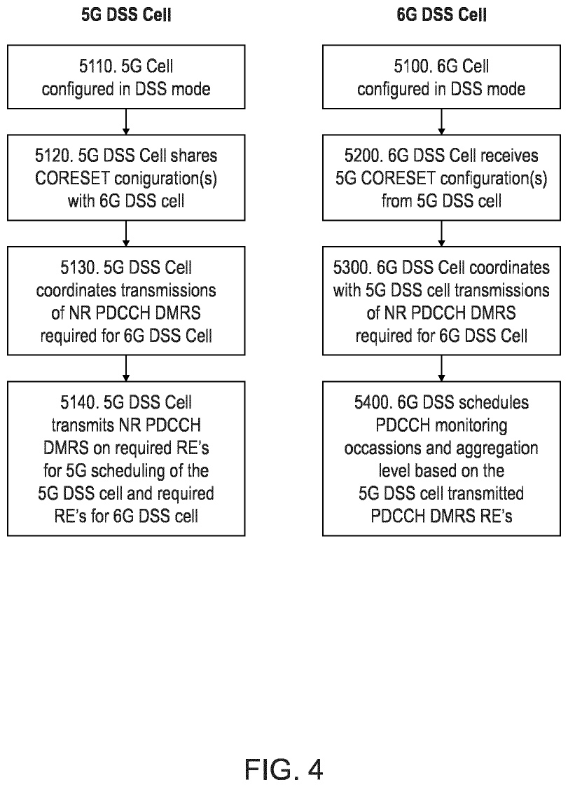

FIG. 4 schematically shows a flow diagram of a method performed at network nodes supporting 5G and 6G cells respectively according to an example embodiment;

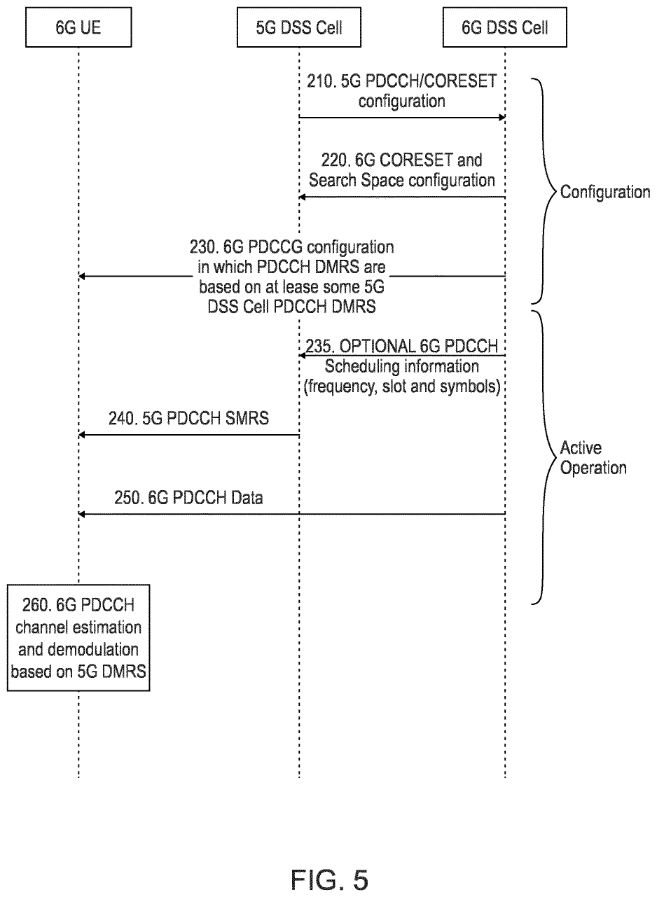

FIG. 5 schematically shows a signalling diagram showing signals transmitted between a UE, 5G and 6G cell according to an example embodiment; and

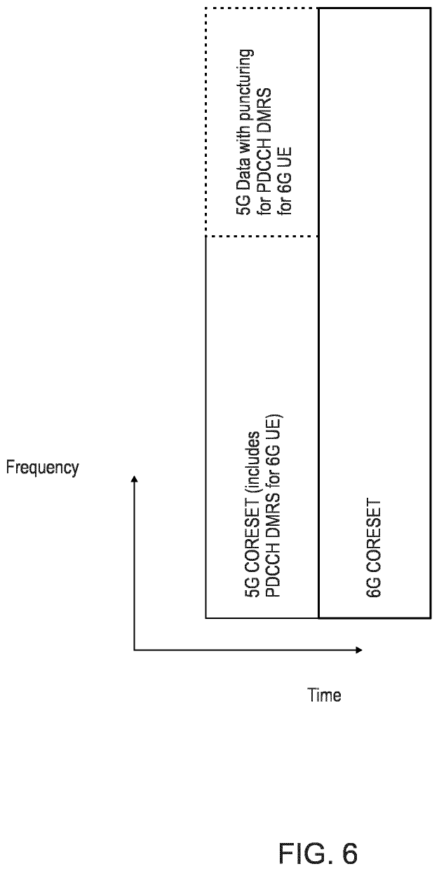

FIG. 6 illustrates a further example of the control resource sets for 5G and 6G cells dynamically sharing spectrum.

### DETAILED DESCRIPTION

Before discussing the example embodiments in any more detail, first an overview will be provided.

This application relates to the so-called DSS (Dynamic Spectrum Sharing) feature where apparatus using different radio access technologies dynamically share at least a portion of the same frequency band.

In embodiments, reference signals for use by user equipment in a cell for channel estimation that are broadcast or transmitted by a node configured to use a radio access technology other than 6G, may be re-used in 6G cells that overlap geographically and in the frequency spectrum with these cells. In this way the 6G nodes do not have to allocate resources for transmission of these reference signals themselves.

In some embodiments this requires coordination between the 6G node and the other node.

In some embodiments, the other radio access technology is 5G, 5G uses DMRS signals as reference signals for channel estimation and embodiments seek to use the same signals for 6G channel estimation such that these signals can be re-used in the 6G cell where there is overlap with a 5G cell thereby reducing the amount of signals that need to be sent.

A user equipment may be aware that it is within radio coverage of a 6G cell that uses dynamic spectrum sharing in response to receipt of an indicator indicating this. In response the user equipment may monitor for reference signals in a portion of the channel allocated to the other radio access channel. This indicator may not be an explicit indicator it may be an indicator of the presence of some other radio access technology signal such as a 5G signal, or it may be some synch. Channel construction that will indicate to the user equipment that there may be dynamic spectrum sharing and thus, that the reference signals may be located within a portion of the channel that is allocated to this other radio access technology.

The indicator may be a configuration indicator and may be received at the apparatus prior to connection of the apparatus to the cell and in such a case it may be received within a master information block and/or a system information block. Alternatively, it may be received in a signal following radio resource connection to the cell.

The monitored portion of the frequency band may be at least as wide and overlap with the frequency band for transmission of the 6G physical downlink control channel. The channel estimation is to be used for decoding this channel and thus, should preferably encompass this channel.

Where the frequency band of the control resource set CORSEST of the other radio technology is wider than the 6G PDCCH then in some cases the reference signal may be transmitted in the entire COREST for the apparatus operating in the other radio access technology.

Coordination between the nodes, may involve exchanging information regarding the configuration of the reference signals, and/or information regarding when they are required and when they should be transmitted.

In this regard, there the 6G node is not transmitting its own reference signals but is relying on the reference signals transmitted by a further apparatus then it is important that these reference signals are transmitted whenever user equipment configured for 6G operation may require them. Thus, in some case the 6G node may indicate to the node of the other radio access technology that it should generate and transmit these reference signals irrespective of whether it has any user equipment of its own radio access technology that require them. In this way, the 6G node can be confident that reference signals are transmitted when user equipment configured for 6G operation may need them.

Alternatively, rather than indicating to the other node to transmit them all the time, it may indicate to the node when there is a requirement for these reference signals and request that it transmit them at this point. It may do this in response to determining that it has a user equipment within its cell that requires a reference signal. In some cases, the request to generate and transmit these signals may indicate a predetermined time during which this should be done.

Where the other radio access technology is 5G, the reference signals may be NR PDCCH DMRS and these are included as part of the NR PDCCH symbols since there are no longer always on Cell Reference Symbols as there were in LTE. These NR PDCCH DMRS can also be leveraged for beamforming the PDCCH. Since these PDCCH DMRS are sent every 3 subcarriers per PRB (12 in FIG. 2), these lead to a significant overhead and reduced PDCCH capacity.

PDCCH capacity for an NR DSS cell has been a bottle neck.

LTE PDCCH decoding is based on LTE Control Resource Set (CRS) symbols spread out across the slot (a group of symbols) and hence the channel estimation and data symbols are not localized within the same symbols, but they do span potentially the same frequency resources.

Embodiments recognise that that the channel estimation symbols for 6G PDCCH do not need to be localized in time or frequency within the 6G PDCCH data resources. Indeed, the 6G PDCCH resources for channel estimation may be provided by the reference signals of another RAT, in some embodiments by the DMRS of 5G.

In embodiments where 6G FDD (frequency division duplexing) bands do not employ mMIMO solutions then the 5G PDCCH DMRS symbols can be re-utilized for 6G PDCCH decoding.

This offloads the 6G PDCCH symbols from having to send PDCCH DMRS, thereby providing an increase in capacity of 25% per PRB used for Control Channel Elements (CCE's).

Note, for TDD (time division duplexing) bands where mMIMO is commonly deployed, the above framework can be used for scenarios where i) the same beam is scheduled for 5G and 6G users, ii) different beams are scheduled for 5G and 6G users but search space resource elements needed for the 6G user to perform channel estimation based on the 5G PDCCH DMRS are not employed by the 5G PDCCH scheduler.

FIG. 1 shows a communications network 1 comprising a 6G network node 2 configured to support providing a 6G cell 3 and a second network node 4 associated with a radio access technology (RAT) other than 6G, in this particular embodiment 5G/NR, and configured to support providing a second cell 5. The network nodes 2, 4 share an antenna system 6, i.e., they are co-sited or collocated. It will be appreciated that the size and shape of the cells 3, 5 in FIG. 1 are merely for illustration purposes and may in practice vary from what is shown. The network nodes 2, 4 share an antenna system 6 configured for transmitting and broadcasting signals to UEs within the cells 3, 5.

Embodiments relate to the situation in which a UE 10 configured for 6G operation is within the radio coverage of cells 3, 5 of both network nodes 2, 4 and thus can detect signals associated with both network nodes 2, 4. UE 10 and network nodes 2, 4 each comprise at least a processor 7 and a memory 8.

In this embodiment, UE 10 may receive a signal from 6G network node 2 indicating that reference signals in the form of DMRS are available for channel estimation. This signal may be received prior to the UE connecting to the 6G cell within a MIB or SIB. Network node 2 may provide details of the DMRS that are broadcast by network node 4 within the CORESET of the 5G cell. This allows the UE 10 to perform channel estimation using the reference signals broadcast by the 5G network node 4. In this way UEs within the overlapping cells may each use the same DMRS signals for channel estimation significantly reducing the overhead associated with this signalling.

FIG. 2 shows how PDCCH resource blocks in a 6G CORESET can be freed up by re-using reference signals, such as DMRS 12, broadcast in the 5G CORESET for channel estimation and demodulation of 6G PDCCH data transmissions. The right-hand symbols represent the 6G CORESET and the left-hand symbols represent the 5G CORESET. DMRS 12 are broadcast 1 in every 4 resource blocks in the 5G CORSET. The DMRS 12 can be used for channel estimation and demodulation of 6G PDCCH data transmissions. The co-located network nodes 2, 4 and shared antenna assembly 6 (see FIG. 1) mean that channel estimation for signals transmitted in a 5G channel will be valid for those transmitted in the 6G channel that has an overlapping frequency band. In this way, more of the 6G CORESET is available for PDCCH data transmissions (rather than for reference signals), thereby reducing the bottleneck mentioned above that is typically associated with 5G DSS.

In some embodiments, the DMRS 12 are common to both 5G and 6G.

In some embodiments, DMRS for 6G compatible UEs are broadcast in the 5G CORESET by the 5G network node even when no 5G compatible UEs are within the 5G cell. This ensures 6G compatible UEs, which may be invisible to the 5G network node, continue to receive suitable DMRS for channel estimation and demodulation of 6G PDCCH transmissions. In other embodiments, DMRS may be broadcast by the 6G network node when there are no 5G UEs in the overlapping cells. Both of the above require some cooperation between the network nodes, and signals may be transmitted between them, sharing details of the reference signals and of the requirements of each.

FIG. 2 shows an exemplary configuration of the 6G PDCCH DMRS 12 that could be configured in symbols 0 and 1 (left-hand columns) and the 6G PDCCH data in symbols 2 and 3 (right-hand columns). The UE should not assume anything about resource blocks inside the 5G CORESET not used for DMRS 12. With this, the 5G CORESET defined in symbols 0 and 1, is not visible in the 6G specification in general, however, in embodiments the configuration sent to the UE defines a case where the 6G PDCCH DMRS is the 5G PDCCH DMRS located in the earlier symbol(s) within the resources blocks of the 5G CORESET.

FIG. 3 shows a flow chart illustrating steps performed at the 6G UE. In step S10 the UE is made aware that it is camping on a 6G DSS cell. In some embodiments, the UE receives an indicator indicating that the UE is within radio coverage of a 6G cell that is using dynamic spectrum sharing with another radio access technology other than 6G. This may simply be an indicator that there is an overlapping 5G cell and the UE may be configured to recognise that DSS is used in such a scenario.

In step S20, the UE is configured at least with a first set of symbols on which a different RAT's PDCCH DMRS Resource Element are transmitted. In other words, the UE receives a configuration indicator indicating a configuration of a set of resource elements that are used for transmission or broadcast of the reference signals and indicating the portion of the bandwidth used for this. This could be by means of, e.g., the Master Information Block, System Information Block, or following connection some procedure in RRC connected state. In some example embodiments, the UE may use some 6G specific DMRS for decoding the 6G PDCCH in addition to the 5G PDCCH DMRS.

In S30, the UE is configured with a second set of symbols in which it should perform the PDCCH monitoring, e.g., via blind decodes.

In S40, during configured UE monitoring occasions the 6G UE performs PDCCH channel estimation on a first set of resource elements which may or may not be fully overlapping with its PDCCH monitoring resource elements.

In S50, the UE performs the PDCCH decoding attempts based on the channel estimation results from S40.

FIG. 4 shows flow charts illustrating steps in a method performed at each of the 5G network node and 6G DSS network node. For the 5G DSS cell:

In S110, the 5G cell (network node) is configured in DSS mode.

In S120, the 5G DSS cell informs the 6G DSS cell of its CORESET configurations. This is done by generating configuration information for transmission to the 6G DSS cell, the configuration information includes an indication of a configuration of resource elements used by the 5G DSS cell to broadcast reference signals, in this case DMRS. Typically, the DMRS sequence of the PDCCH DMRS is initialized with a pseudo random sequence based on the cells Physical Cell Identity (PCI), however, other DMRS configurations are possible. If the 5G DSS cell DMRS sequence is not initialized based on the 5G DSS cell PCI, the initialization parameters may also be shared with the 6G DSS cell.

In S130, the 5G DSS cell coordinates transmissions (or broadcasts) of NR PDCCH DMRS required for 6G DSS cell.

In S140, the 5G DSS cell transmits NR PDCCH DMRS on required Res (resource elements) for 5G scheduling of the 5G DSS cell and required Res for 6G DSS cell. Thus, the 5G network node broadcasts the Res that are required for the 6G cell and indeed in embodiments, these are the same Res that re required for its own cell.

For the 5G DSS cell:

In S100, the 6G cell is configured in DSS mode.

In S200, the 6G DSS cell receives the 5G CORESET configuration(s) from the 5G DSS cell.

In S300, the 6G DSS cell coordinates with the 5G DSS cell transmissions of NR PDCCH DMRS required for the 6G DSS cell.

In S400, the 6G DSS cell schedules PDCCH monitoring occasions and aggregation level based on the 5G DSS cell transmitted PDCCH DMRS RE's.

It should be highlighted here that as a result of S130 and S300, the 6G DSS cell may be aware that the 5G PDCCH DMRS intended to be transmitted by the 5G DSS cell for the 6G UE are suboptimal and hence the 6G DSS cell may alter the 6G UEs Aggregation Levels or employ power control to compensate for this fact S400.

FIG. 5 shows a signalling diagram illustrating the communication between the elements of the network. In step 210, the 6G DSS cell receives, from the 5G DSS cell, the 5G PDCCH/CORESET configuration information. In step 220, the 6G DSS cell responds by transmitting the 6G CORESET and search space configuration to the 5G DSS cell. In step 230, the 6G DSS cell transmits an indication to the 6G UE of the 6G PDCCH configuration in which PDCCH DMRS are based on at least some 5G DSS cell PDCCH DMRS.

In the optional step 235, the 6G DSS cell transmits scheduling information, such as frequency, slot and symbol information, to the 5G DSS cell. This may indicate that the DMRS reference signal should be transmitted within the 6G CORESET which may be a sub band of the 5G CORESET, or may include a portion of a bandwidth outside of the 5G CORESET.

In step 240, the 5G DSS cell broadcasts 5G PDCCH DMRS to the 6G UE. The 6G DSS cell may then transmit 6G PDCCH data to the 6G UE in step 250. In step 260, the 6G UE performs channel estimation and demodulation on the 6G PDCCH based on the 5G DMRS.

For some 5G configurations where large cell bandwidths are configured, the 5G CORESET may not expand the full cell bandwidth and it may not be possible to frequency multiplex 5G and 6G CORESETS, hence the described embodiment could be employed as shown in FIG. 6. FIG. 6 shows how through the coordination step (S130 and S300), the 5G DSS could also transmit 5G PDCCH DMRS Res outside the CORESETs configured for 5G UEs (in the top left region) but within the frequency band of the CORESET for 6G operation and specifically for 6G UEs in the 6G DSS cell. This top left region in FIG. 6 could also be used for 5G data transmission via puncturing or rate matching around the PDCCH DMRS Res.

Potential advantages of the above-described embodiments include:
Increasing 6G PDCCH capacity by re-using NR PDCCH DMRS, and
6G UEs being able to perform NR PDCCH DMRS decoding allowing them to perform NR PDCCH interference cancellation for scenarios where, e.g., 6G and 5G cells are not DSS cells, but adjacent cells operating in co-channel frequencies. The incapability to support this was also a major pitfall of the 4G-5G DSS framework.

In summary, in embodiments, at a high level the framework comprises:
1. 5G DSS Cell gNB (network node 4) which shares 5G CORESET Configuration(s) with 6G DSS cell (network node 2) over, e.g., Xn.
2. 5G DSS cell and 6G DSS cell may coordinate on the transmission of PDCCH DMRS RE:
   a. 5G DSS cell may transmit PDCCH DMRS in all possible Res in the most simplistic embodiment and this would not require coordination between the 5G and 6G cells.
   b. In a further embodiment, the 6G DSS cell informs the 5G cell of its intended PDCCH allocations in the 6G CORESET and then the 5G DSS Cell would transmit 5G PDCCH DMRS only on Res which are intended for 6G UEs even if there is no 5G PDCCH transmission that would lead to 5G transmitting also the 5G PDCCH DMRS.
3. 6G UE configured with:
   a. In some embodiments, 5G CORESET performs channel estimation based on the 5G DMRS RE's.
      i. The UE could be configured to always expect 5G DMRS in all Res of the 5G CORESET when there is a 6G PDCCH transmitted, or to only expect them in a certain region. 'ii. The 5G PDCCH DMRS used for channel estimation may not be exactly aligned with the 6G CORESET.
   b. 6G CORESET to perform blind decodes in a 6G CORESET which does not have to be overlapping with the 5G CORESET.

Note the above embodiments are specifically intended for DSS cells in order to reduce overheads and increase PDCCH capacity while still avoiding the 5G and the 6G cells to jointly and dynamically manage resource allocation. If the same resources would be shared by 5G and 6G PDCCH for the transmission of different signals, collision avoidance would require dynamic resource coordination. In 5G, a UE is unaware that its camping in a DSS cell until it enters RRC connected mode and its capabilities are known by the network node, gNB. At this stage the gNB informs the UE of an LTE CRS rate matching pattern which is an indication to the UE that it could be a DSS cell.

The UE not being aware of it camping in a DSS cell during its time in Idle state was an issue for 4G-5G DSS which led to increased overheads and reduced spectral efficiency. Hence here the assumption is that the 6G UE would be aware it is camping on a 6G DSS cell in idle mode and then this would enable the above framework to be employed for 6G Common Search Spaces and Users Search Spaces. This might be possible by the transmission of this in formation in a MIB (master information block) or SIB (system information block). In embodiments where this is not the case and the 6G UE is not aware that it is camping on a DSS cell, then UE dedicated search spaces may be used to allow the UE to find the DMRS.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
© hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

### LIST OF ABBREVIATIONS

AL [PDCCH] Aggregation Level
BLER Block Error Rate
CCE Control Channel Element
CORESET Control Resource Set
CRS [LTE] Cell-specific Reference Signal
CSI Channel State Information
CSS Common Search Space
DMRS Demodulation Reference Signal
DSS Dynamic Spectrum Sharing
eNB Evolved Node B (LTE network node)
FG Feature Group
IE Information Element
gNB gNode B (5G NR network node)
IC Integrated Circuit
LTE Long Term Evolution
KPI Key Performance Indicator
mMIMO massive Multiple Input Multiple Output
NB Node B (network node)
NR New Radio
O&M Operation and Maintenance
OFDM Orthogonal Frequency Division Multiplexing
PDCCH Physical Downlink Control Channel
PRB Physical Resource Block
Pcell Primary Cell
PCI Physical Cell Identity
RAT Radio Access Technology
RE Resource Element
RSRP Reference Signal Received Power
RSRQ Reference Signal Received Quality
Scell Secondary Cell
SINR Signal to Interference and Noise Ratio
SNR Signal to Noise Ratio
SS [PDCCH] Search Space
TS Technical Specification
UE User Equipment
WI Work Item

1-25. (canceled)

26. An apparatus configured for 6G operation, said apparatus comprising:
at least one processor; and
at least one memory storing instructions that when executed by the at least one processor cause the apparatus at least to perform:
channel estimation for a 6G channel by:
monitoring for reference signals within resource elements in at least a portion of a frequency band, said resource elements being allocated to an other radio access technology; and
performing said channel estimation based on said monitored reference signals.

27. An apparatus according to claim 26, wherein said reference signals are common to both said other radio access technology and to 6G.

28. An apparatus according to claim 26, wherein said monitored at least a portion of said frequency band comprises at least a frequency band for transmission of a 6G physical downlink control channel PDCCH.

29. An apparatus according to claim 26, said apparatus being further caused, prior to performing said channel estimation to:
receive an indicator indicating that said apparatus is within radio coverage of a 6G cell using dynamic spectrum sharing with said other radio access technology and to commence said step of monitoring in response to receipt of said indicator.

30. An apparatus according to claim 26, said apparatus being further caused to perform:
receiving a configuration indicator indicating a configuration of said set of resource elements and a frequency band for said reference signals, and in response to receipt of said configuration indicator monitoring within said at least a portion of said frequency band for said reference signals; and
performing said channel estimation based on said monitored reference signals and said at least a portion of said frequency band.

31. An apparatus according to claim 30, wherein said configuration indicator indicates a frequency band of a control resource set of said other radio access technology as said frequency band, said apparatus performing channel estimation in dependence upon at least a portion of said frequency band of said other radio access technology.

32. An apparatus according to claim 30, wherein said configuration indicator is received in at least one of the following: a master information block or a system information block.

33. An apparatus according to claim 26, said apparatus being further caused to perform:
receiving signals on a 6G physical downlink control channel; and
performing decoding operations on said signals using said channel estimation.

34. An apparatus configured to support providing radio coverage in a 6G cell and configured to dynamically share a radio spectrum with a further apparatus using another radio access technology, said apparatus comprising:
at least one processor; and
at least one memory storing instructions that when executed by the at least one processor cause the apparatus at least to perform:
receiving information from said further apparatus providing radio coverage in a cell of said other radio access technology said cell at least partially overlapping geographically and in a frequency band with said 6G cell, said information comprising configuration information for a control resource set of said other radio access technology, said configuration information including an indication of a configuration of resource elements used by said further apparatus to transmit reference signals;
generating an indication of configuration information relating to said resource elements; and
transmitting said indication to user equipment configured to support 6G operation within said cell.

35. An apparatus according to claim 34, wherein said indication of said configuration of resource elements comprises an indication of a frequency band in which said resource elements are transmitted.

36. An apparatus according to claim 35, wherein said frequency band comprises a frequency band of a control resource set of said other radio access technology.

37. An apparatus according to claim 35, wherein said frequency band comprises a frequency band of a control resource set of said 6G cell.

38. An apparatus according to claim 35, wherein said processor is configured to cause said apparatus to perform:
generating an indicator indicating that said reference signals should be generated and transmitted irrespective of whether user equipment configured for the other radio access technology require the signals; and
transmitting said indicator to said further apparatus.

39. An apparatus according to claim 35, wherein said processor is configured to cause said apparatus to perform:
determining that a user equipment configured for 6G operation is within said cell and in response:
generating an indicator indicating that said reference signals should be generated and transmitted for a predetermined time; and
transmitting said indicator to said further apparatus.

40. An apparatus according to claim 35, wherein said processor is configured to cause said apparatus to perform:
generating an indicator indicating a frequency band for transmission of said reference signals by said further apparatus when said further apparatus determines that user equipment configured for operation using the other radio access technology do not require the reference signals; and
transmitting said indicator to said further apparatus.

41. An apparatus according to claim 35, wherein said processor is configured to cause said apparatus to perform:
in response to receiving an indication that said further apparatus is not currently transmitting said reference signals, to generate and transmit said reference signals using at least some of said resource elements used by said further apparatus when transmitting said reference signals.

42. An apparatus configured to support providing radio coverage in a 5G cell and configured to dynamically share a radio spectrum with an apparatus providing radio coverage in a 6G cell, said 6G cell at least partially overlapping geographically in frequency band with said 5G cell, said apparatus, comprising:
at least one processor; and
at least one memory storing instructions that when executed by the at least one processor cause the apparatus at least to perform:
generating configuration information for transmission to said apparatus supporting providing radio coverage in said 6G cell, said configuration information including an indication of a configuration of resource elements used by said apparatus to transmit reference signals;
transmitting said reference signals on said resource elements.

43. An apparatus according to claim 42, the apparatus being further caused to perform:
receiving an indication from said apparatus supporting radio coverage in said 6G cell indicating that said reference signals should be transmitted irrespective of whether user equipment configured for 5G operation require said reference signals; and
in response, transmitting said reference signals irrespective of whether user equipment configured for 5G operation are within said 5G cell and require said reference signals.

44. An apparatus according to claim 42, the apparatus being further caused to perform:
receiving an indication from said apparatus supporting radio coverage in said 6G cell indicating that said reference signals should be transmitted in a different predefined frequency band when user equipment configured for 5G operation do not require said reference signals; and
determining whether user equipment configured for 5G operation are within said 5G cell and require said reference signals if so:
transmitting said reference signals in a frequency band of a 5G control resource set; and if not
transmitting said reference signals in said predefined frequency band.
